(19) United States
(12) Patent Application Publication
(10) Pub. No.: US 2002/0162925 A1
(43) Pub. Date: Nov. 7, 2002

(54) Wall attachment display apparatus

(76) Inventor: Robin Song, Los Angeles, CA (US)

Correspondence Address: Jerry H. Noh, 3350 Wilshire blvd. Suite 1110, Los Angeles, CA, 90010, US

(21) Appl. No.: 09/850,618

(22) Filed: May 7, 2001

(51) Int. Cl. A47K 1/00; F16L 3/08

(52) U.S. Cl. 248/223.41

(57) ABSTRACT

A display holding apparatus for attachment onto a wall comprising a second plate member removably engaging a first plate member. The first plate member having a back side, a front side, and two or more holes therethrough extending from the back side to the front side for mounting onto a wall. The first plate member further having an elongated u-shaped channel extending from a top edge substantially towards the central portion. A recessed portion is defined on the back side of the first plate member extending adjacent to the channel and forming a pocket with the wall surface when the first plate member is attached to the wall. The second plate member being adapted to engage the first plate member. The second plate member comprising a front side, a back side, and a catch member protruding from the back side. The catch member having a neck portion and an enlarged head portion. The neck portion being adapted to slide into said channel, and the head portion being adapted to slide into and fit substantially tight within the pocket formed by the wall and the recessed portion of the first plate member.

### BACKGROUND OF THE INVENTION

1. Field of the Invention

The present invention relates to a wall attachment apparatus. More particularly, the present invention is directed to an attachment apparatus for hanging miscellaneous display devices onto a wall surface.

2. Description of the Related Art

Conventionally, hooks and fasteners, or nails are used for hanging miscellaneous objects on walls. For heavier objects, screws and or bolts are used to directly set a particular device onto a wall. However, in bolting objects directly onto walls, there can be an inconvenience in removing the device from the wall or in changing the display device hung on the wall in that the screw or bolt must be removed.

There is no prior art which teaches a wall attachment display device as taught in the present invention.

It is an objective of the present invention to provide a wall attachment device which allows easy replacement of a display device hung on a wall. It is another objective of the present invention to provide a wall attachment device which securely hangs objects onto walls.

### SUMMARY

The present invention is a display holding apparatus for attachment onto a wall. The apparatus comprises a second plate member removably engaging a first plate member. The first plate member has a back side, a front side, and two or more holes therethrough extending from the back side to the front side. The first plate member can be mounted onto a wall surface by using screws or nail to pass through the holes and into the wall. The first plate member further has an elongated u-shaped channel extending from an edge substantially towards the central portion. A recessed portion is defined on the back side of the first plate member extending adjacent said channel, and the recessed portion forms a pair of straight opposed parallel ridges on the back side of the first plate member. When the first plate member is attached to a wall, a pocket is defined between the recessed portion of the first plate member and the wall.

The second plate member is adapted to engage said first plate member. The second plate member comprises a front side, a back side, and a catch member protruding from the back side. The catch member has a neck portion and an enlarged head portion. The neck portion is adapted to slide into said channel, and the head portion is sized and shaped to slide into and fit substantially tight within the pocket formed by the wall and the first plate member.

The second plate member connects to the first plate member with the back side of the second plate member abutting the front side of the first plate member. A display member can be attached to protrude from the front side of the second plate member to allow the apparatus to serve as a wall mounted display device. Further, the apparatus can have a securing means to keep the second plate member securely engaged to the first plate member.

### BRIEF DESCRIPTION OF THE DRAWINGS

FIG. 1 is a perspective view of the present invention;

FIG. 2 is a front view of the present invention;

FIG. 3 is a side view of the present invention;

FIG. 3A is a side cross-sectional view of the present invention cut along the 3A-3A line of FIG. 2;

FIG. 4 is a back view of the present invention;

FIG. 5 is an exploded front view of the present invention;

FIG. 6 is a back exploded view of the present invention;

FIG. 7 is a side view of an embodiment of the present invention;

FIG. 7A is a perspective view of an alternative embodiment of the present invention;

FIG. 8 is a side exploded view of the present invention with the first plate member shown in cross-section cut along the 8-8 line of FIG. 5; and,

FIG. 9 is a perspective exploded view of the present invention shown with the first plate member connected to a wall.

### DETAILED DESCRIPTION

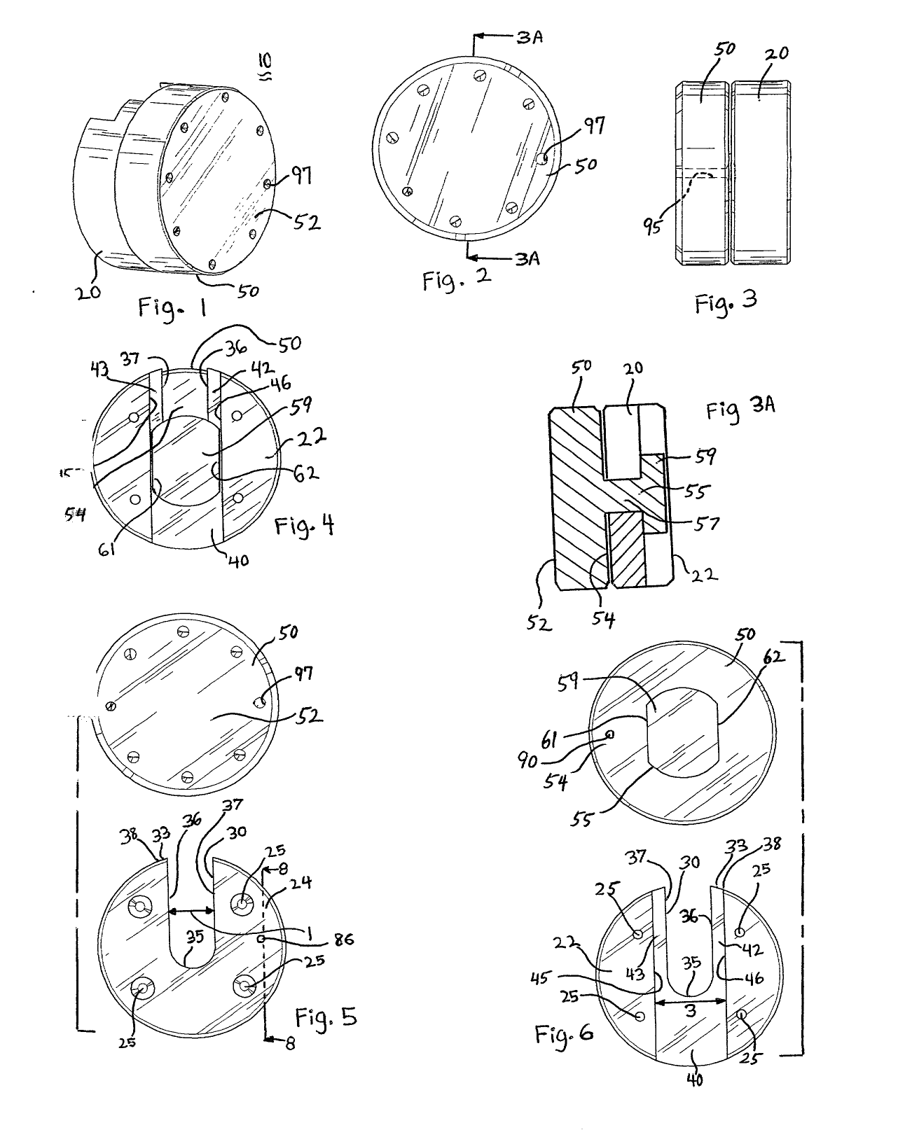

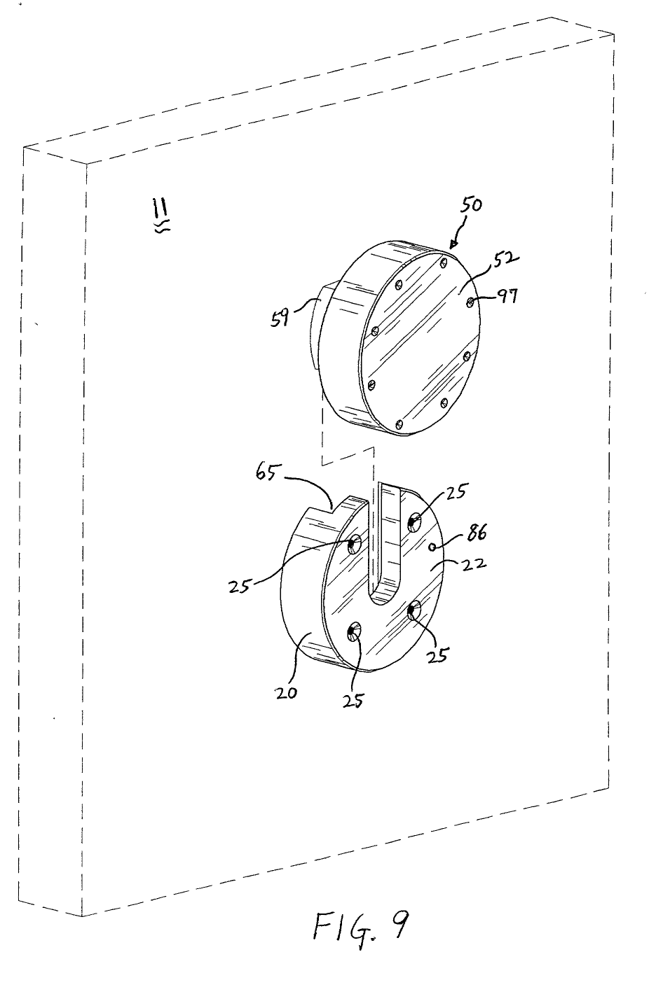

As illustrated in FIGS. 1 to 9, the present invention is an apparatus 10 for attachment onto a wall 11 for hanging miscellaneous display devices thereon. The apparatus 10 comprises a second plate member 50 removably engaging with a first plate member 20.

As illustrated in FIGS. 4 to 6, the first plate member 20 comprises a back side 22 and front side 24, both sides being substantially flat. The first plate member 20 further defines two or more holes 25 therethrough extending from the back side 22 to the front side 24. The holes 25 are used for mounting the first plate member 20 onto a wall using screws or nails (not shown) to pass through the holes 25 and into the wall 11. The first plate member 20 further has an elongated u-shaped channel 30 extending from a top edge 33 substantially towards the central portion 35 of the first plate member 20. The channel 30 is of a uniform thickness and has straight opposed edges 36, 37 leading to the central portion 35. The width between the opposed edges of the channel is of a first predetermined length 1, and the depth of the channel is of a second determined length. The back side 22 of the first plate member 20 further defines an elongated flat recessed portion 40 extending from a top edge portion 38 of the first plated member 20 and extending adjacent to the channel 30. The recessed portion 40 and channel 30 define a pair of opposed shoulders 42, 43 adjacent to the channel 30 on the back side 22 of the first plate member 20. The recessed portion 40 further defines a pair of straight opposed parallel ridges 45, 46 adjacent to the pair of opposed shoulders 42, 43, and the ridges 45, 46 are of a uniform thickness. The width between the opposed ridges 45, 46 is of a third predetermined length 3.

The second plate member 50 adapted for engaging the first plate member 20 comprises a front side 52, a substantially flat back side 54, and a catch member 55 protruding from the back side 54. The catch member 55 has a neck portion 57 and an enlarged substantially flat head portion 59. The neck portion 57 has a width slightly smaller than the first predetermined length 1 of the width of the channel 30 so that the neck portion 57 can slidably engage and fit within the channel 30. The neck portion 57 is also slightly longer than the thickness of the channel 30.

The enlarged head portion 59 of the catch member 55 has a pair of opposed parallel sides 61, 62 abutting the pair of opposed ridges 45, 46 of the recessed portion 40 when the first plate member 20 is attached to the second plate member 50. The head portion 59 has a width between the opposed parallel sides 61, 62 which is slightly smaller than the third predetermined length 3 of the width of the recessed portion 40 to allow the head portion 59 to slidably engage and fit within the recessed portion 40 between the opposed ridges 45, 46. Further, the head portion 59 is sized and shaped to slide into and fit substantially tight within the recessed portion 40 of the first plate member 20 when the first plate member 20 is attached to the wall 11. When the first plate member 20 is attached to the wall 11, a pocket 65 is defined between the back side 22 of the first plate member 20 and the wall 11. The catch member 55 is of a predetermined dimension allowing it to slide into the pocket 65 and fit snugly therein.

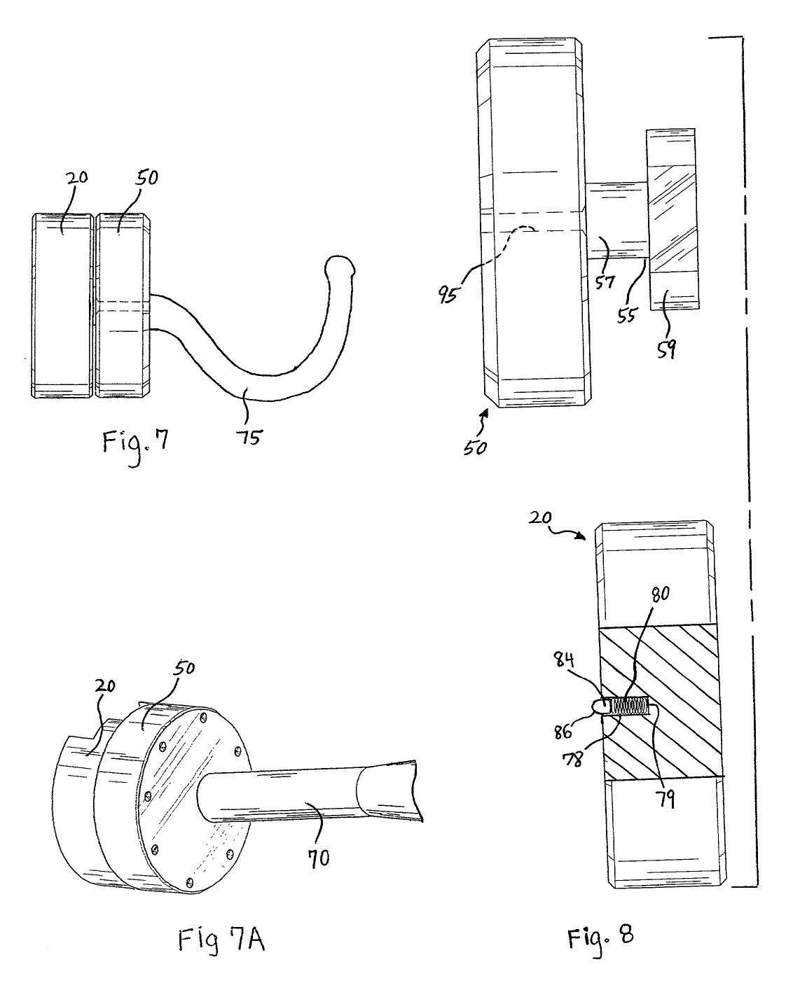

The second plate member 50 connects to the first plate member 20 with the back side 54 of the second plate member 50 abutting the front side 24 of the first plate member 20 as the neck portion 57 of the second plate member 50 slides into the channel 30 towards and to the central portion 35 of the first plate member 20. To be utilized as a display device, the apparatus 10 further comprises a rod member 70 protruding from the front side 52 of the second plate member 50 as shown in FIG. 7A. The rod member 70 can have any miscellaneous device connected thereto known in the art to be useful as a display device. Further, instead of a rod member 70, in an alternative embodiment, as shown in FIG. 7, a hook member 75 can be attached to the front side 52 of the second plate member 50.

To keep the second plate member 50 secure to the first plate member 20, the apparatus 10 can further have a securing means comprising a first bore 78 extending from the front side 24 of the first plate member 20. As illustrated in FIG. 8, the bore 78 has an end point 79 within the first plate member 20, and further, the bore 78 defines an opening at the front side 24. A spring member 80 is placed within the first bore 78, and one end of the spring abuts the end point 79 of the first bore 78 whereas the other end of the spring 80 connects to a head member 84 covering the opening of the first bore 78. The head member 84 has a rounded portion 86 extending out of the bore 78 and protruding from the opening. The spring member 80 is biased to urge the rounded portion 86 of the head member 84 to protrude from the opening of the first bore 78. The second plate member 50 comprises a recess 90 protruding into the back side 54 corresponding to the position of the head member 84 of the first plate member 20. Further, the recess 90 of the second plate member 50 is dimensioned to receive the rounded portion 86 of the head member 84. In an alternative embodiment, a second bore 95 can be formed through the first plate member 50 extending from the front side 52 and ending into the recessed 90 formed on the back side 54. The second bore 95 has an opening 97 on the front side 52.

While particular embodiments according to the invention have been illustrated and described above, it will be clear that the invention can take a variety of forms and embodiments within the scope of the appended claims.

In the claims:

1. An apparatus for attachment onto a wall, said apparatus comprising:
a first plate member comprising:
a back side, a substantially flat front side, and defining two or more holes extending through said first member from said back side to said front side;
said first plate member further having a channel extending from an edge of said first plate member towards substantially the central portion of the first plate member;
said channel having straight opposed edges leading to said central portion;
said channel having a width of a first predetermined length;
said back side of said first plate member further defining an elongated flat recessed portion extending from a top edge portion of said first plated member and extending adjacent said channel;
said recessed portion and channel defining a pair of opposed shoulders adjacent said channel on said back side of said first plate member;
said recessed portion defining a pair of straight opposed ridges adjacent said pair of opposed shoulders;
said recessed portion having a width between said opposed ridges of a third predetermined length;
a second plate member adapted to engage said first plate member, said second plate member comprising:
a front side, a flat back side, and a catch member protruding from said back side;
said catch member having a neck portion and an enlarged head portion;
said neck portion having a width slightly smaller than the first predetermined length of the width of the channel allowing said neck portion to slidably engage and fit within said channel;
said enlarged head portion having a width slightly smaller than the third predetermined length of the width of the recessed portion allowing said head portion to slidably engage and fit within said recessed portion; and,
said enlarged head portion being sized and shaped to slide into and fit substantially tight within said recessed portion of said first plate member when said first plate member is attached to said wall;
whereby said second plate member connects to said first plate member with said back side of said second plate member abutting said front side of said first plate member as said neck portion of said second plate member slides into said channel towards and to said central portion of said first plate member.

2. The apparatus as described in claim 1 further comprising a rod member protruding from said front side of said second plate member.

3. The apparatus as described in claim 1 wherein said first plate member further comprises:
a first bore extending into said first plate member from said front side thereof, said first bore defining an opening at said front side and having an end point within said first plate member;
a spring member disposed within said first bore;
a head member connected to said spring member and covering said opening of said first bore, said head member having a rounded portion protruding from said opening of said first bore;
said spring member biased to urge said rounded portion of said head member to protrude from said opening of said first bore;
and wherein said second plate member further comprises a recess protruding into said back side corresponding to said position of head member of said first plate member, said recess receiving said rounded portion of said head member of said first plate member when said second plate member engages said first plate member.

4. The apparatus as described in claim 1 further comprising a hook member attached to said front side of said second plate member.

5. An apparatus for attachment onto a wall, said apparatus comprising;
a first plate member comprising:
a substantially flat back side, a substantially flat front side, and defining two or more holes extending through said first member from said back side to said front side;
said first plate member further having an elongated u-shaped channel extending from an edge of said first plate member towards substantially the central portion of the first plate member;
said channel having straight opposed edges leading to said central portion;
said channel having a width between said opposed edges of a first predetermined length;
said channel being of a uniform thickness;
said back side of said first plate member further defining an elongated flat recessed portion extending from a top edge portion of said first plated member and extending adjacent said channel;
said recessed portion and channel defining a pair of opposed shoulders adjacent said channel on said back side of said first plate member;
said recessed portion defining a pair of straight opposed parallel ridges adjacent said pair of opposed shoulders, said ridges being of a uniform thickness;
said recessed portion having a width between said opposed ridges of a third predetermined length;
a second plate member adapted to engage said first plate member, said second plate member comprising:
a front side, a flat back side, and a catch member protruding from said back side;
said catch member having a neck portion and an enlarged head portion;
said neck portion having a width slightly smaller than the first predetermined length of the width of the channel allowing said neck portion to slidably engage and fit within said channel, said neck portion being slightly longer than the thickness of said channel;
said enlarged head portion being substantially flat and having a pair of opposed parallel sides abutting said pair of opposed ridges of said recessed portion, said head portion having a width between said opposed parallel sides slightly smaller than the third predetermined length of the width of the recessed portion allowing said head portion to slidably engage and fit within said recessed portion; and,
said head portion being sized and shaped to slide into and fit substantially tight within said recessed portion of said first plate member when said first plate member is attached to said wall;
whereby said second plate member connects to said first plate member with said back side of said second plate member abutting said front side of said first plate member as said neck portion of said second plate member slides into said channel towards and to said central portion of said first plate member.

6. The apparatus as described in claim 5 further comprising a rod member protruding from said front side of said second plate member.

7. The apparatus as described in claim 5 further comprising a hook member attached to said front side of said second plate member.

8. The apparatus as described in claim 5 wherein said first plate member further comprises:
a first bore extending into said first plate member from said front side thereof, said first bore defining an opening at said front side and having an end point within said first plate member;
a spring member disposed within said first bore;
a head member connected to said spring member and covering said opening of said first bore, said head member having a rounded portion protruding from said opening of said first bore;
said spring member biased to urge said rounded portion of said head member to protrude from said opening of said first bore;
and wherein said second plate member further comprises a recess protruding into said back side corresponding to said position of head member of said first plate member, said recess receiving said rounded portion of said head member of said first plate member when said second plate member engages said first plate member.
